(19) United States
(12) Patent Application Publication
(10) Pub. No.: US 2001/0035643 A1
(43) Pub. Date: Nov. 1, 2001

(54) Operating system and process for safety devices in a vehicle

(76) Inventor: Olaf Mueller, Ruesselsheim (DE)

Correspondence Address: MARTIN FLEIT, FLEIT KAIN GIBBONS GUTMAN & BONGINI, 520 BRICKELL KEY DRIVE #A201, MIAMI, FL, 33131, US

(21) Appl. No.: 09/845,218

(22) Filed: Apr. 30, 2001

Related U.S. Application Data
(63) Continuation of application No. 09/227,820, filed on Jan. 11, 1999, now abandoned.

(30) Foreign Application Priority Data
Jan. 9, 1998 (DE) 298 00 264.7
Mar. 20, 1998 (DE) 298 05 080.3
Nov. 12, 1998 (DE) 298 20 306.5
Nov. 12, 1998 (DE) 298 20 307.3

(51) Int. Cl. B60R 22/36

(52) U.S. Cl. 280/806

(57) ABSTRACT

An operating system for a safety device in a vehicle including a driving element housed in a guide housing and coupled to a safety device for its operation. A gas generating device generates a gas pressure in the guide housing. A starting device triggers the generating device to generate gas pressure in two successive, but partially overlapping driving stages. A load limiter coacts with the driving element to insure a predetermined yielding performance of the safety device.

### SPECIFICATION

The invention relates to an operating system for safety devices in a vehicle according to the preamble of claim 1 and to an operating process for safety devices in a vehicle according to the preamble of claim 24.

Such operating devices are, for example, belt tightening devices and contain a guide housing; at least one driving element which is accommodated therein and which is coupled to at least one safety device for its operation; an operating path in the guide housing for the driving element; gas pressure generating devices for generating a gas pressure in a pressure receiving space in the guide housing; and starting devices for triggering the gas pressure generating devices, in which case the at least one driving element can be acted upon by generating a gas pressure in the pressure receiving space for the movement from an inoperative position along the operating path.

A disadvantage in the case of such operating devices, which can, for example, also be used as adjusting devices for seat adjustments, steering wheel adjustments and other safety devices to be mechanically operated, in the event of an accident, is that, after the triggering, the gas pressure rises rapidly and, after a peak value is reached, also falls rapidly. As a result, a high gas pressure for acting upon the driving element is available only for a short time. However, the respective safety devices, on the one hand, require a certain moving and operating path of the driving element which can be covered as fast as possible and, as a rule, on the other hand, only a maximally permissible moving or operating path of the driving element. This means that the used amount of gas must, on the one hand, be large enough and must be made available rapidly enough and must, on the other hand, not be too large. The peak value of the used gas pressure must also be proportioned such that it cannot lead to injuries of the occupants of a vehicle equipped in such a manner by the safety devices themselves in the event of an accident. The course of the pressure, which the gas pressure generating devices used so far make available, is unsatisfactory in view of the described demands.

It is therefore an object of the present invention to provide operating systems and operating processes for safety devices in a vehicle by means of which an operation of the safety devices can be ensured which is improved with respect to its scope and course.

According to the invention, this is achieved by means of a system according to claim 1 as well as a process according to claim 24. Preferred and advantageous further developments of the invention are found in the subclaims and their combinations. In particular, the invention also comprises analogies between the system and process variants according to the invention.

In addition to the initially mentioned type-forming characteristics, it is provided in the case of the system according to the invention that the gas pressure generating devices contain at least two successively triggerable driving stages and a triggering control by means of which the generating of the gas pressure takes place in a partially superimposed manner by at least two successive driving stages in the pressure receiving space.

As a result, a gas pressure course is achieved which provides a longer lasting maximum. This has the effect that sufficient gas pressure is available for satisfactorily moving the driving element without having to accept an excessive gas pressure peak. The invention advantageously also permits that the driving elements, such as pistons, move faster and have a stronger pull. Finally, the elimination of an excessive gas pressure peak leads to the avoidance of a risk of injury to the occupants by the safety devices themselves.

Preferably, it is also provided within the scope of the invention that the triggering control contains mechanical, chemical, electric and/or electronic retarding and triggering devices which can be triggered by a driving stage for triggering the correspondingly following driving stage. In a further development thereof, chemical retarding and triggering devices are connected behind the mechanical retarding and triggering devices.

The mechanical retarding and triggering devices preferably contain an ignition triggering mechanism, which can be operated by means of a triggered driving stage, and also an igniter for the driving stage which follows the triggered driving stage, in which case a delay between the triggerings of two successive driving stages can be defined by the duration of the course of the ignition triggering mechanism and the ignition performance of the igniter. In this case, it is particularly preferred for the ignition triggering mechanism to contain an ignition piston and a valve, and for the ignition piston, by means of the driving stage, which operates the ignition triggering mechanism, for triggering the igniter of the driving stage which follows, to be movable toward this igniter. The last embodiment can be further developed in that the mechanical retarding and triggering devices contain a valve by means of which the gas flows between two successive driving stages can be controlled in that it is closed until the triggering of the driving stage which follows by a triggered driving stage and is opened up subsequently in order to ensure an operation of the ignition piston in the closed condition and a gas flow from the driving stage which follows into the pressure receiving space in the open condition. In this case, the valve is preferably provided in the ignition piston.

According to a further development of the invention, the mechanical retarding and triggering devices can contain an ignition triggering mechanism which can be operated by means of a triggered driving stage, in which case a delay between the triggerings of two successive driving stages can be defined by the duration of the sequence of the ignition triggering mechanism. In this case, it can also be provided that the ignition triggering mechanism contains a pressure collection space which can be filled with pressure gas by a triggered driving stage and which separates the triggered driving stage from the driving stage which is to be triggered subsequently, as well as a threshold device, such as a bursting disk or similarly acting valve, which closes off the pressure collection space toward the driving stage which is to be triggered subsequently and opens it up at a defined pressure in the pressure collection space in order to cause the ignition of the driving stage, which is to be triggered subsequently, by means of the pressure gas from the triggered driving stage. Such a bursting plate or disk may (word missing in the German—translator) weakenings or weak points for determining the gas pressure in the pressure collection space, at which the bursting plate bursts. In addition, a free zone or soft zone can be provided between the bursting plate and the driving stage to be triggered in order to provide a sufficient path for the bursting of the bursting plate.

According to another alternative or additional embodiment of the operating system according to the invention, it is provided that the first driving stage of the gas pressure generating devices is electrically or electronically triggerable.

In order to meet the requirements in the event of accidents, it is preferred for the triggering control for triggering a driving stage to be laid out to be approximately 1 ms to approximately 5 ms, preferably approximately 2 ms, after the triggering of the preceding driving stage.

In particular, the driving element is a piston of a belt tightening device or of an adjusting device.

The invention can be used particularly advantageously when a multiplicity of guiding paths and corresponding driving elements are contained which can be acted upon by common gas pressure generating devices by way of a pressure receiving space. This permits a space- and cost-saving arrangement, in which case the invention provides a sufficient gas pressure and gas pressure course for ensuring the operation of the multiplicity of driving elements. This aspect and its further developments are of independent inventive significance also together with one-stage gas pressure generating devices.

The guide housing preferably contains an extruded profile which optionally contains a multiplicity of guide paths.

A construction is also particularly efficient in which the gas pressure generating devices are constructed as a cartridge and/or are housed in the guide housing.

Since the pressure receiving space is enlarged because of the movement of the driving element after the action by a driving stage, it is advantageous and therefore preferable for a driving stage to generate a larger amount of gas than the preceding driving stage.

According to another further development of the invention, a load limiting device is provided in order to ensure a predetermined yielding performance of the safety device, to which the driving device is coupled, if the driving element after an action by a counterforce which is higher than the latter by means of an occupant, is blocked with respect to a return motion. Such a load limiting device may be provided, for example, between a piston and a thimble for coupling the driving element to the safety devices. In this case, but also in addition, the load limiting device may be material deforming, cutting and/or hydraulic. This aspect of the use of a corresponding load limiting device and its further developments are also of independent inventive significance together with one-stage gas pressure generating devices.

It is also preferred for the guide housing according to another embodiment of the invention to form a stiffening part of a vehicle structure and particularly a cross traverse. This aspect and its further developments are also of independent inventive significance together with one-stage gas pressure generating devices.

In the case of the operating process according to the invention for safety devices in a vehicle, it is provided that, by means of gas pressure generating devices in a pressure receiving space, a gas pressure is generated which acts upon at least one driving element along an operating path, which driving element is coupled to at least one safety device for its operation, and that the gas pressure in the pressure receiving space is generated by at least two successive and partially superimposed gas pressure surges of individual driving stages of the gas pressure generating devices.

A preferred further development thereof is such that, by means of the triggering of a driving stage, mechanical, chemical, electric and/or electronic retarding and triggering devices for the subsequent driving stage are activated.

The invention will be described in detail in the following by means of embodiments with reference to the drawings.

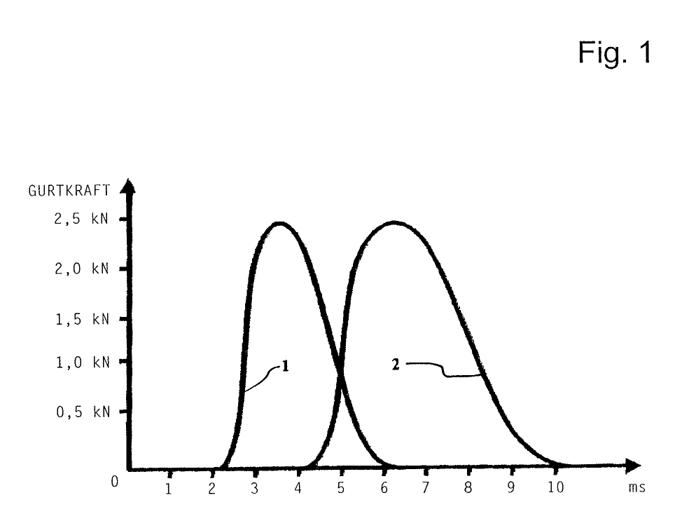

FIG. 1 is a schematic view of a gas pressure course of a first embodiment of an operating system for safety devices in a vehicle according to the invention;

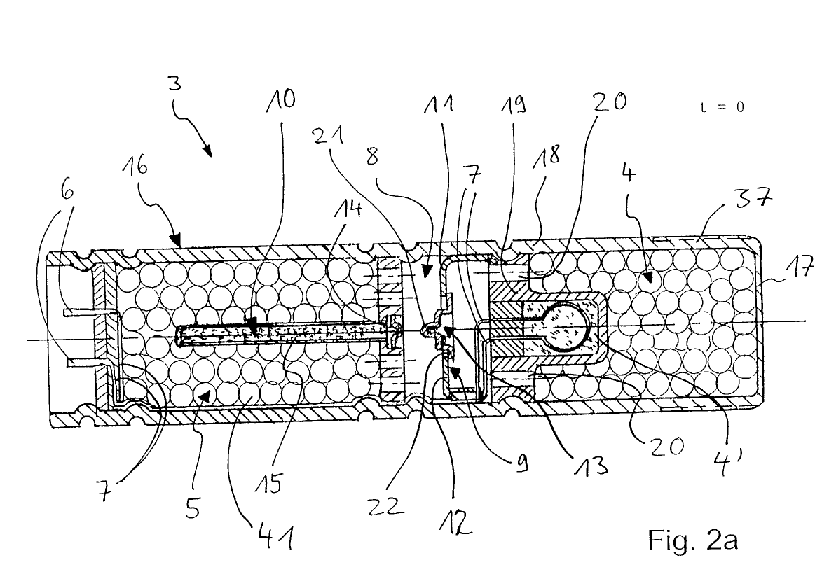

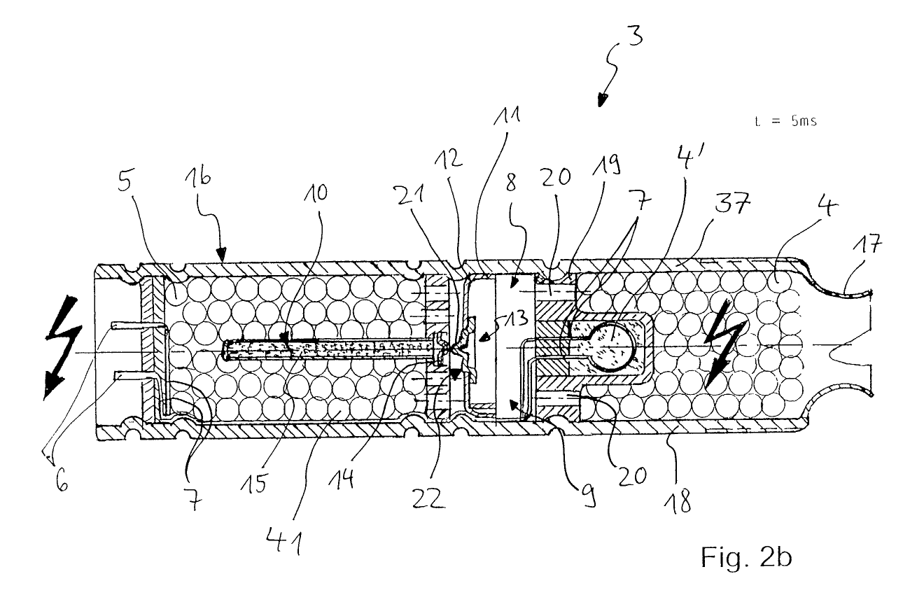

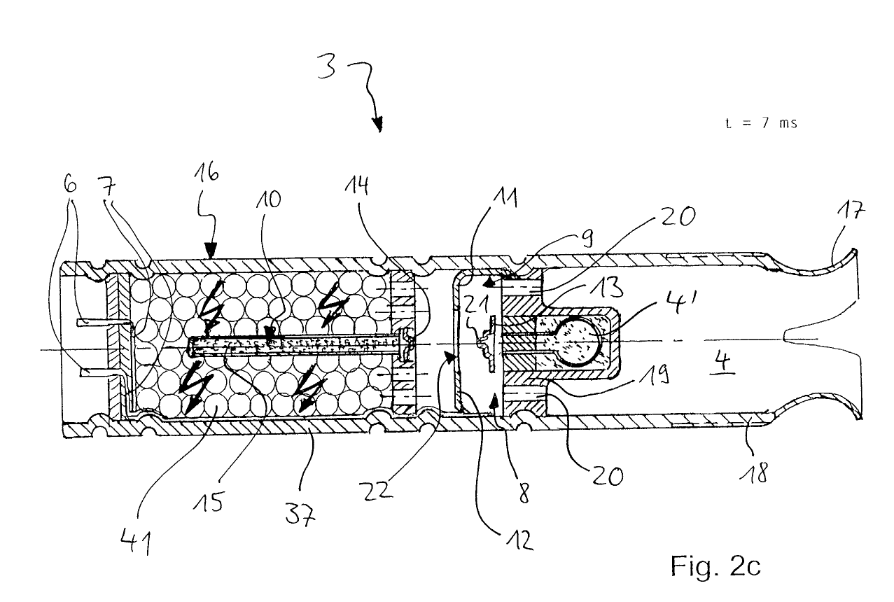

FIGS. 2a, 2b and 2c are schematic sectional views of successive conditions of a first embodiment of an operating system for safety devices in a vehicle according to the invention;

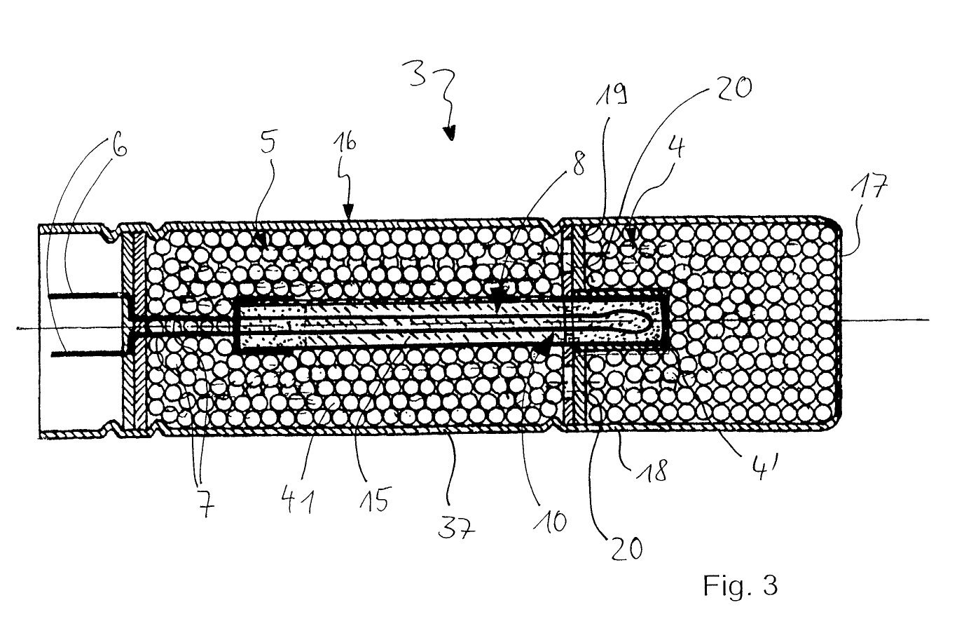

FIG. 3 is a schematic sectional view of a second embodiment of an operating system for safety devices in a vehicle according to the invention;

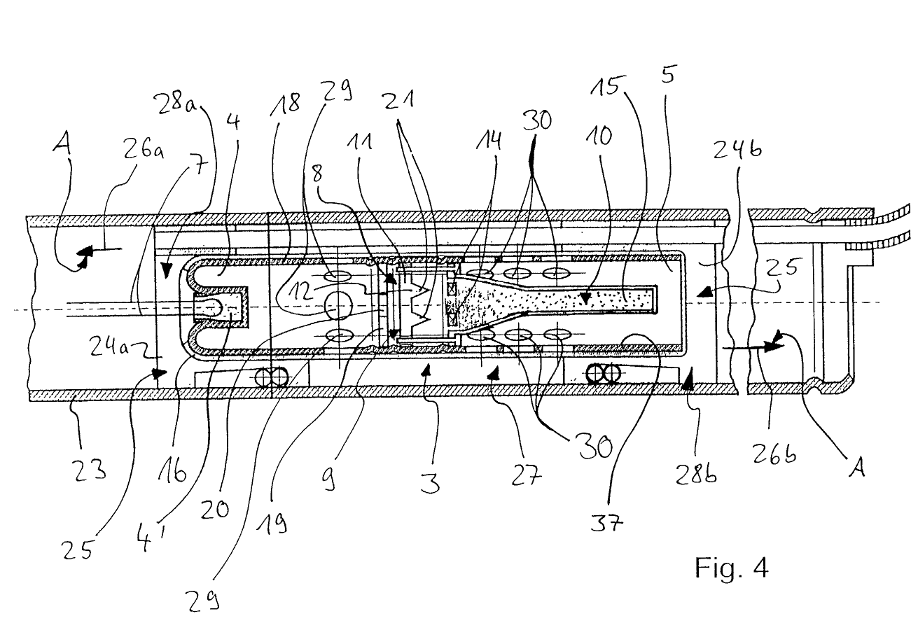

FIG. 4 is a schematic sectional view of a third embodiment of an operating system for safety devices in a vehicle according to the invention;

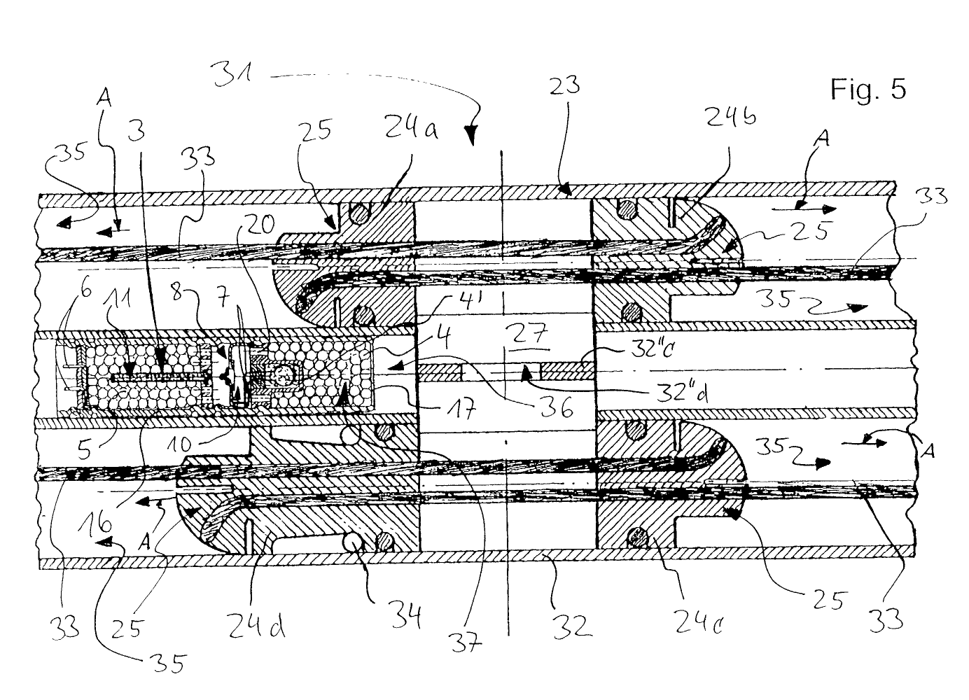

FIG. 5 is a schematic sectional view of a fourth embodiment of an operating system for safety devices in a vehicle according to the invention;

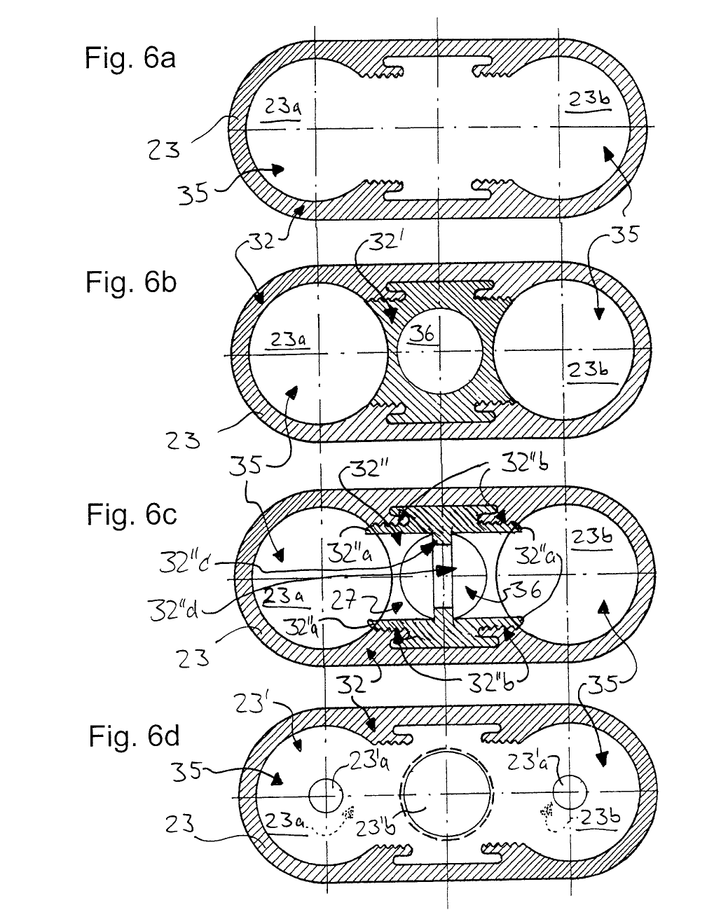

FIGS. 6a, 6b, 6c and 6d are four sectional views of the fourth embodiment of an operating system for safety devices in a vehicle according to FIG. 5;

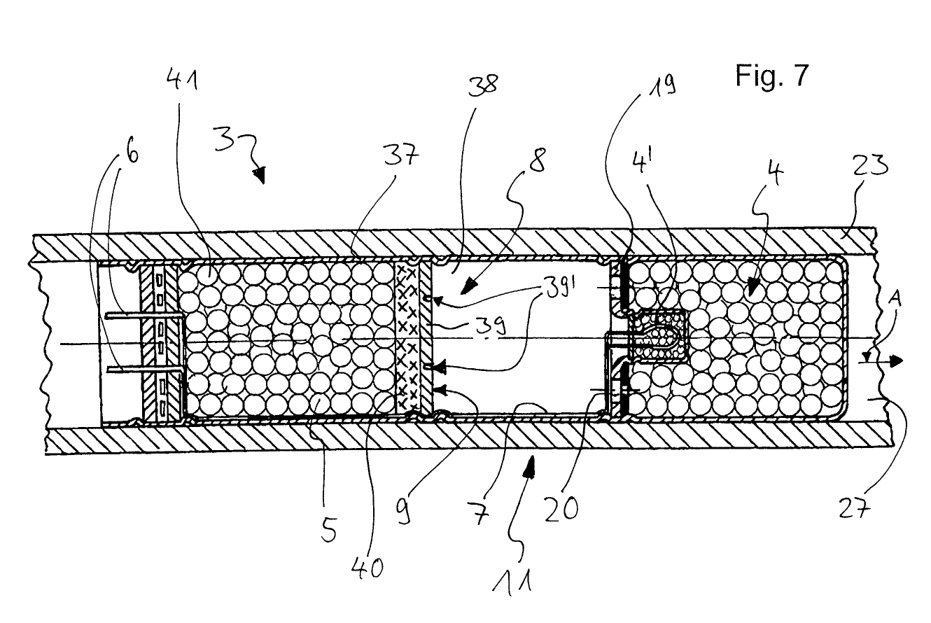

FIG. 7 is a schematic sectional view of a fifth embodiment of an operating system for safety devices in a vehicle according to the invention;

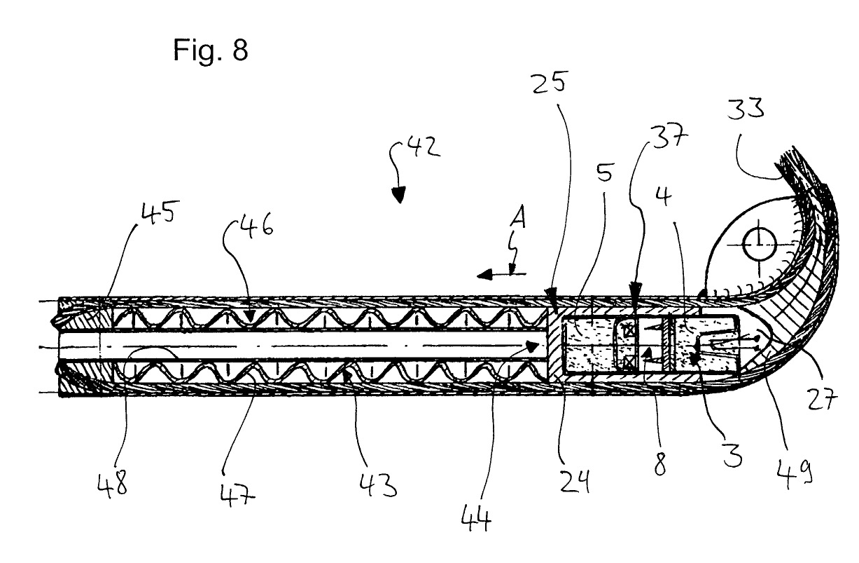

FIG. 8 is a schematic sectional view of a sixth embodiment of an operating system for safety devices in a vehicle according to the invention;

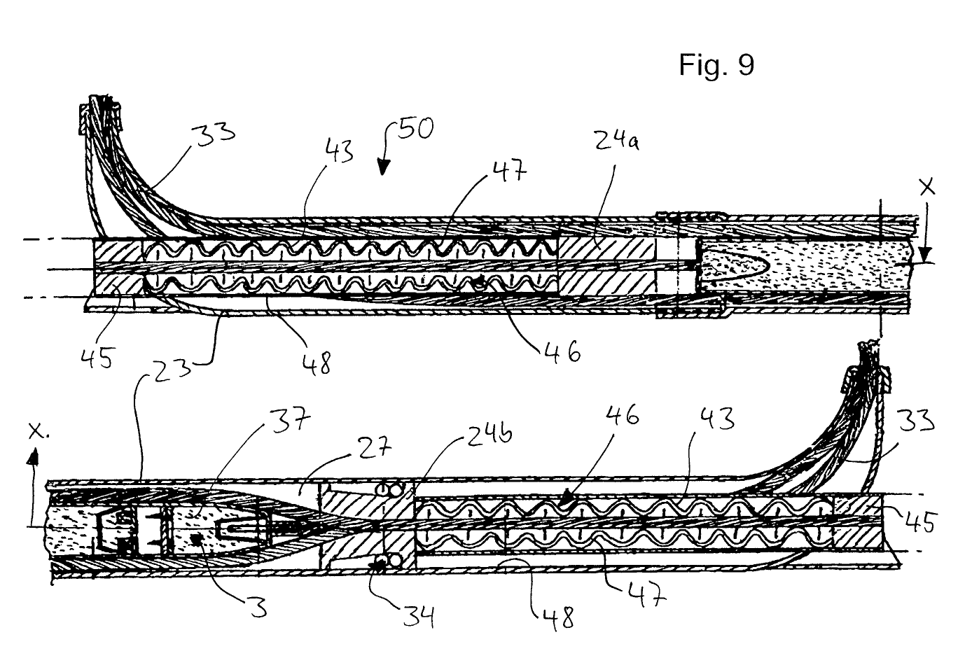

FIG. 9 is a schematic two-part sectional view of a seventh embodiment of an operating system for safety devices in a vehicle according to the invention;

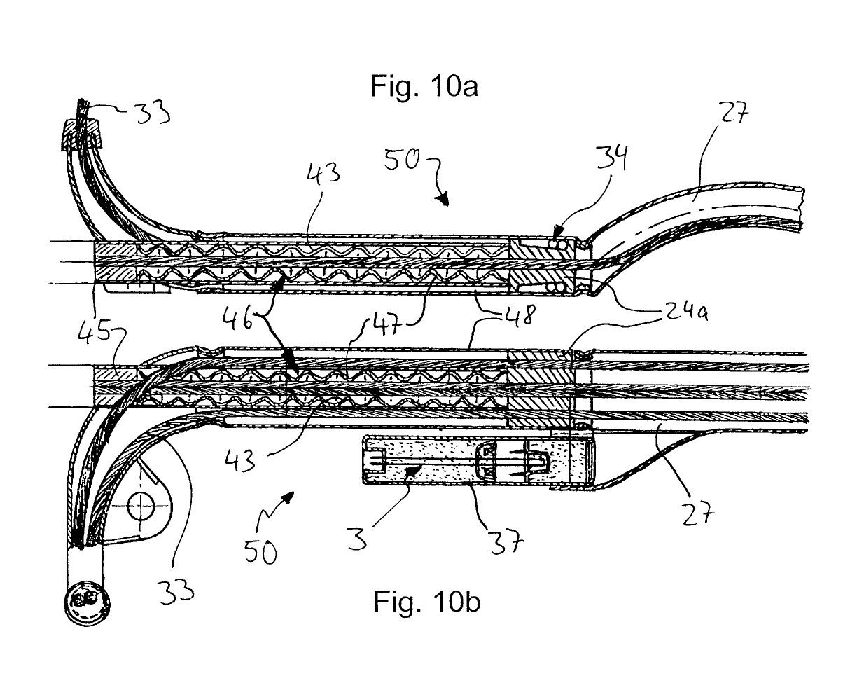

FIGS. 10a and 10b are schematic sectional views of an eighth embodiment of an operating system for safety devices in a vehicle according to the invention;

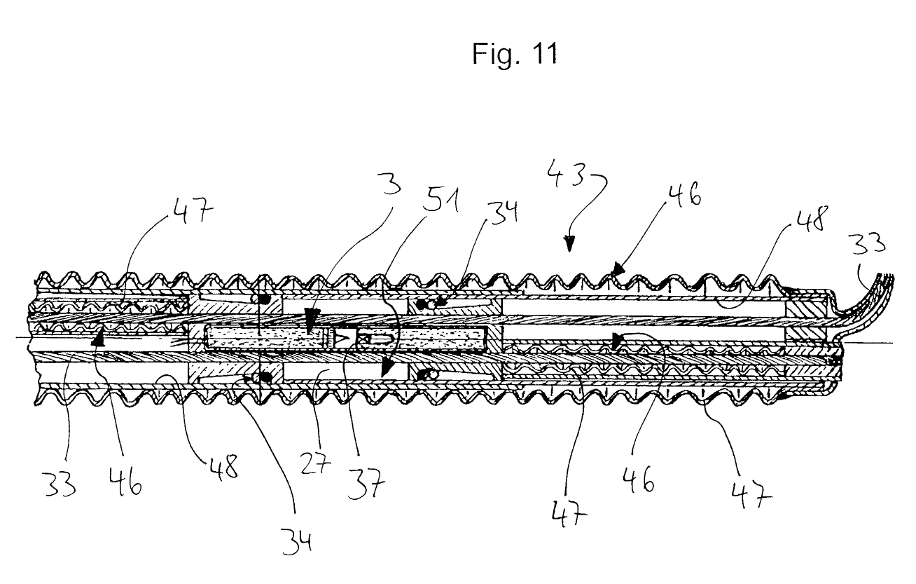

FIG. 11 is a schematic partial sectional view of a ninth embodiment of an operating system for safety devices in a vehicle according to the invention;

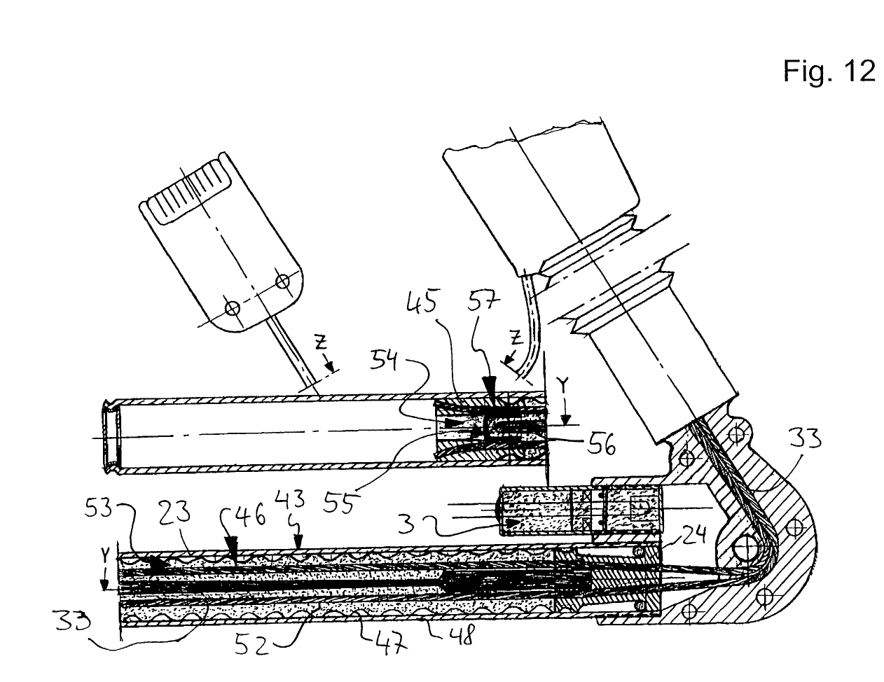

FIG. 12 is a schematic two-part sectional view of a tenth embodiment of an operating system for safety devices in a vehicle according to the invention;

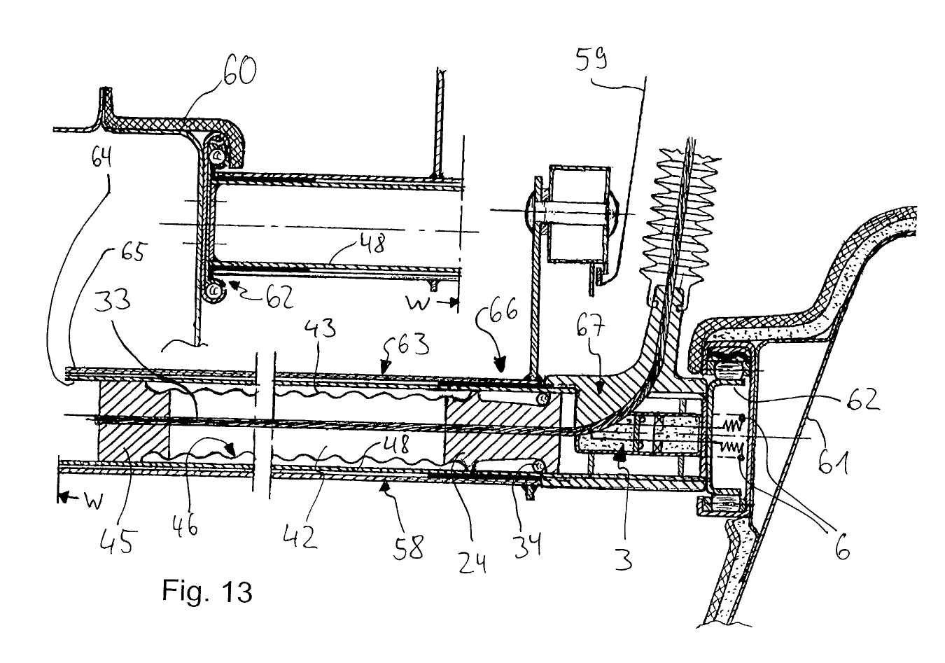

FIG. 13 is a schematic two-part sectional view of an eleventh embodiment of an operating system for safety devices in a vehicle according to the invention;

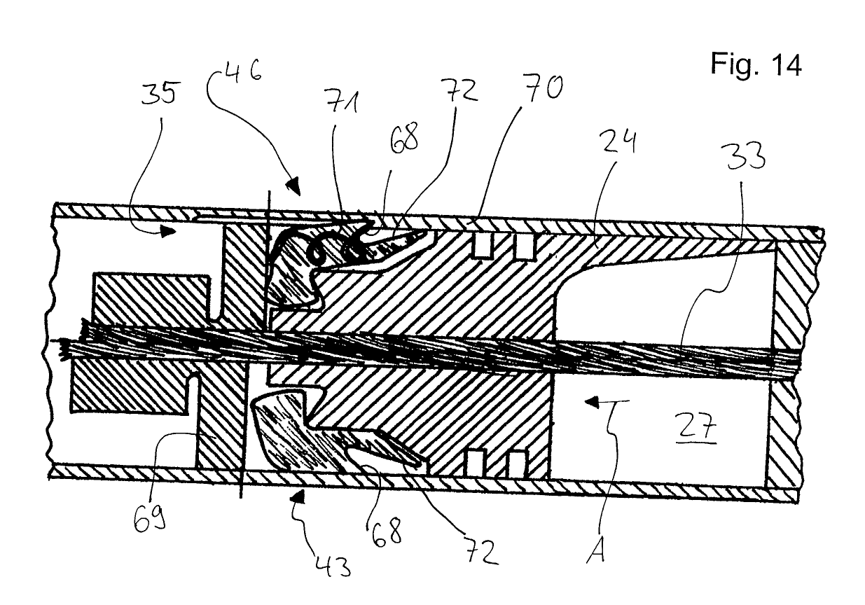

FIG. 14 is a schematic partial sectional view of a load limiting device of a twelfth embodiment of an operating system for safety devices in a vehicle according to the invention; and

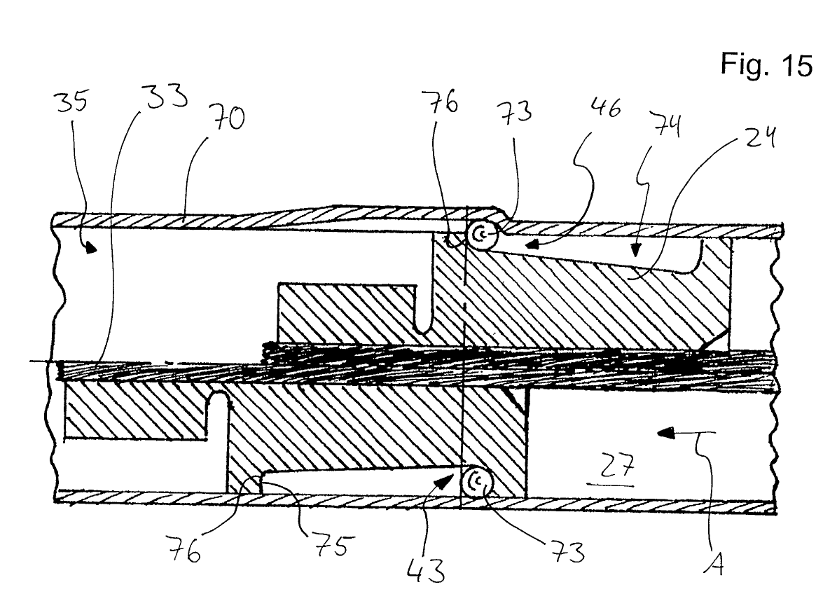

FIG. 15 is a schematic partial sectional view of a load limiting device of a thirteenth embodiment of an operating system for safety devices in a vehicle according to the invention.

In all figures of the drawing, identical and similar or identically and similarly acting parts all have the same reference numbers. By means of the representations in the figures, additional characteristics of the illustrated embodiments are easily recognizable even if no separate reference is made to these characteristics in the following description. In particular, by a comparison of the individual representations and embodiments, common aspects and differences between the latter are obtained so that the description of parts and characteristics, which were already discussed in connection with an embodiment, is omitted in order to avoid repetitions in the description of embodiments which follow, since such parts and characteristics can easily be found by a comparison of the individual illustrations, reference numbers and descriptions of preceding embodiments. This also applies in the event that not all parts and characteristics in all figures are provided with reference number because the individual parts and characteristics can easily be recognized and assigned from the representations themselves and their comparison in the different figures.

FIG. 1 is a schematic illustration of the pressure course of two-stage gas pressure generating devices as a first general embodiment of an operating system for safety devices in vehicles, Curve 1 shows the gas pressure course of a first driving stage and curve 2 illustrates the gas pressure course of a second driving stage of the gas pressure generating devices. The force is concretely illustrated which is exercised on a seat belt which has a belt tightening device as the operating system according to the invention, in kN along the time-related course of the triggerings of the two driving stages.

The first driving stage is triggered approximately 5 ms after an event, such as an accident. After another approximately 2 ms, that is, approximately 7 ms after the triggering event, the second driving stage is also triggered. However, at this time, the gas pressure from the first driving stage has not yet completely diminished or gone back to zero (see curve 1). The gas pressure of the second driving stage (see curve 2) of the gas pressure generating devices, which is already rising at this moment, is superimposed on the still existing remainder of the gas pressure of the first driving stage of the gas pressure generating devices, so that the sum of both pressures is available and thus a pressure level is obtained which is schematically outlined by a broken line. This demonstrates that, by means of the operating system according to the invention, a maximal gas pressure for driving a driving element is made available for a longer period of time than if only a single driving stage were used.

Such a two-stage operating system can be implemented, for example, according to a first embodiment which is schematically illustrated as a sectional view in FIGS. 2a, 2b and 2c. FIGS. 2a, 2b and 2c illustrate conditions of gas pressure generating devices 3 at different times, specifically at a time t=0 ms (FIG. 2a), t=5 ms (FIG. 2b) and t=7 ms (FIG. 2c) after an event which results in the triggering of the operating system. The gas pressure generating devices 3 contain a first pyrotechnic driving stage 4 and a second pyrotechnic driving stage 5.

FIG. 2a shows that the first driving stage 4 and the second driving stage 5 of the gas pressure generating devices 3 are both untriggered. The first driving stage 4 can be electrically triggered by means of electric contacts 6 and lines 7 by way of an electric igniter 4. The second driving stage 5 can be triggered by way of a triggering control 8. The triggering control 8 contains mechanical as well as chemical retarding and triggering devices 9 and 10.

The mechanical retarding and triggering devices 9 contain an ignition triggering mechanism 11 which contains an ignition piston 12 and a valve 13 as well as an igniter 14 for the second driving stage 5. In the second driving stage 5, chemical retarding and triggering devices 10 are also provided which contain a chemical ignition retarder 15. The first driving stage 4 and the second driving stage 5 as well as the triggering control 8 are housed as a cartridge in a common housing 16.

The representation of FIG. 2b shows the condition of the two-stage gas pressure generating devices 3 after 5 ms following a triggering. More precisely, up to this point in time, a triggering of the first driving stage 4 took place by way of the electric contacts 6 and the lines 7 as well as the electric igniter 4′. The triggering or ignition of the first driving stage 4 has the result that the housing 16 rips open at its weakest point, for the purpose of which the front wall 17 has a thinner construction than the peripheral wall 18 and a boundary wall 19 which faces the second driving stage 5. Through the torn-open front wall 17, the gas generated in the first driving stage 4 exits into a pressure receiving space of a guide housing for at least one driving element for operating safety devices (not shown here; see description below, for example, concerning FIGS. 4 or 5 and FIGS. 4 and 5).

In the boundary wall 19 of the first driving stage 4, gas passage ducts 20 are situated through which gas can also pass. This gas flow from the first driving stage 4 results in a gas pressure which acts upon the ignition piston 12. The valve 13 is placed from that side onto the ignition piston 12 which is acted upon by this gas pressure of the first driving stage 4, and is therefore held in a closed condition by this gas pressure from the first driving stage 4. This gas pressure from the first driving stage 4 therefore has the result that the ignition piston 12 is accelerated toward the second driving stage 5, where it impacts on the igniter 14, triggering the latter. In the illustrated embodiment, the valve 13 is designed such that it also forms an ignition pin 21 which, during the movement of the ignition piston 12 to the second driving stage 5 and therefore to its igniter 14 impacts on the latter. This impacting onto the igniter 14 already at least loosens the valve 13 or even at least partially opens it.

By means of the igniter 14, an ignition now takes place of the chemical ignition retarder 15 of the chemical retarding and triggering devices 10 in the second driving stage 5. This chemical ignition retarder 15 requires approximately 2 ms before it ignites the second driving stage 5, which is illustrated in FIG. 2c. The gas pressure generated in the second driving stage 5 spreads and results in a gas flow through the weakest point which is formed by the already loosened or even at least partially opened valve 13, which therefore exposes a valve opening 22 in the ignition piston 12. Since the valve 13 no longer hinders the gas flow from the second driving stage 5, the corresponding gas pressure can expand through the thus open valve opening 22 and further through the gas passage ducts 20 in the boundary wall 19 of the first driving stage 4 into the latter. Through the burst front wall 17, the gas pressure can then be made available outside the cartridge housing 16 in a pressure receiving space of a guide housing for at least one driving element for operating safety devices (not shown here; see description below, for example, concerning FIG. 4 or 5 and FIGS. 4 and 5).

The flash signs in FIGS. 2b and 2c symbolically represent ignitions or explosions.

Summarizing, the sequence illustrated in FIGS. 2a to 2c can be represented as follows in the manner of an example:

Beginning from the starting condition in FIG. 2a, an electric ignition of the first driving stage first takes place, whereby the ignition piston 12 is acted upon, for example, by way of holes in a bottom wall of the first driving stage 4. This ignition piston 12 impacts on a mechanical igniter 14 which may be connected with a booster or charge amplifier (not shown). Such a booster may also be used as a chemical ignition retarder 15 and may be designed such that, as required, it retards the ignition of the second driving stage 5. After the explosion of the second driving stage 5, the thus generated gas flows through the valve opening 22 in the ignition piston 12, in which case a multiplicity of such valve openings 22 may be provided in the ignition piston 12 or past it. Because of the construction in FIGS. 2a to 2c, the ignition piston 12 may also be called a two-part ring piston which consists of a ring-shaped piston part or outer ring and of the valve 13 as the inner part with the ignition pin 21. This inner part, which may also be called an igniter pot and, in the example discussed here, can be considered as being composed of an inner ring with the ignition pin 21, is pressed by the pressure gas out of the actual ignition piston 12 acting as the outer ring and exposes the path of the gas by way of the bottom holes or generally gas passage ducts 20 of the first driving stage 4. The above-described mechanical ignition due to impact for the second driving stage 5 is controlled by the two-part construction, for example, in the form of a double ring as a valve, since the valve is pressure-sealed in the direction of the impact ignition and releases the gas in the opposite direction.

FIG. 3 is a schematic sectional view of a second embodiment of an operating system. In contrast to the preceding construction, which is illustrated in FIGS. 2a to 2c, the triggering control 8 contains only chemical retarding and triggering devices 10. For this purpose, a chemical ignition retarder 15 is provided which is ignited in the course of the burning of the first driving stage 4. It may also be provided that the electric ignition of the first driving stage 4, simultaneously to the latter, also ignites the chemical ignition retarder 15 and the retarding time to the ignition of the second driving stage 5 is exclusively the result of the burning time of the chemical ignition retarder 15. Finally, according to another alternative, the chemical ignition retarder 15 may also not be ignited until the very end of the burning of the first driving stage 4. The remaining construction of this embodiment of gas pressure generating devices 3 is analogous to the construction illustrated in FIGS. 2a to 2c. In particular, the gas flow and therefore the spreading of the gas pressure takes place from the second driving stage 5 through the gas passage ducts 20 in the boundary wall 19 of the first driving stage 4 and then through the latter and finally through the front wall 17 to outside the cartridge housing 16 into a pressure receiving space of a guide housing for at least one driving element for operating safety devices (not shown here; see description below, for example, concerning FIG. 4 or 5 and FIGS. 4 and 5).

A third embodiment of the gas pressure generating devices 3 of an operating system according to the invention for safety devices in a vehicle is shown as a schematic sectional view in FIG. 4. As mentioned above, such operating systems may, for example, be belt tightening devices for seat belts, but also other mechanical adjusting devices, as, for example, for withdrawing steering columns and steering wheels in the event of accidents.

FIG. 4 illustrates the gas pressure generating devices 3 accommodated in their housing 16, as they are housed in a guide housing 23. Instead of the gas pressure generating devices 3 according to the third embodiment discussed here, gas pressure generating devices 3 according to the first or second embodiments of FIGS. 2a to 2c and 3 may be used correspondingly.

As indicated in the sectional representation of FIG. 4, two pistons 24a and 24b are also accommodated in the guide housing 23, which pistons 24a and 24b represent driving elements 25 and can be moved along operating paths according to the arrows 26a and 26b.

Not only the gas pressure generating devices 3 but also a pressure receiving space 27 are arranged between the two pistons 24a and 24b, into which pressure receiving space 27 gas pressure expands which is generated by means of the gas pressure generating devices 3. If it was generated, this gas pressure acts upon the two pistons 24a and 24b for the movement out of the inoperative positions 28a and 28b illustrated in FIG. 4 along their operating paths (arrows 26a and 26b).

In contrast to the first and second embodiments according to FIGS. 2a to 2c and 3, the gas outflow from the gas pressure generating devices 3 does not take place through the front wall 17 of the cartridge housing 16 but through the gas outlet openings 29 in the peripheral wall 18 of the cartridge housing 16. The triggering control 8 of the present third embodiment is constructed as in the first embodiment in FIGS. 2a to 2c; that is, that first mechanical retarding and triggering devices 9 are operated by the pressure gas from the first driving stage 4 in that an ignition piston 12 is acted upon to move toward the second driving stage 5, where it impacts on the igniter 14 of the second driving stage 5. This igniter 14 first allows an ignition retarder 15 to burn down which, at the end of its burning duration, causes the ignition of the second driving stage 5 itself. However, in the fourth embodiment, the gas outflow from the second driving stage 5 does not take place through a valve in the ignition piston 12, as in the second embodiment according to FIGS. 2a to 2c, but by way of separate gas outlet openings 30 in the peripheral wall 18 of the cartridge housing 16 for the second driving stage 5.

Through these gas outlet openings 30, the pressure gas from the second driving stage 5, also arrives in the pressure receiving space 27, where it contributes to the action upon the two pistons 24a and 24b in addition to the residual pressure which still exists in the pressure receiving space 27 from the generating of gas by means of the first driving stage 4; that is, that the residual gas pressure from the first driving stage 4 is added to the rising gas pressure from the second driving stage 5, so that a longer lasting high pressure level is maintained in the pressure receiving space 27. As a result, the two pistons 24a and 24b can be acted upon by means of a force which remains at least approximately constant for a longer time than if only one propelling charge were ignited. The latter would lead to a high pressure peak which would clearly be above the pressure level implemented according to the invention if by means of one propelling charge the same total force were to be made available for driving the pistons.

As a special characteristic of the third embodiment illustrated in FIG. 4, it should also be taken into account that the ignition piston 12 of the ignition triggering mechanism 11 has two ignition pins 21 by means of which in an aligned manner, two igniters 14 are provided for the chemical ignition retarder 15. This has the advantage that the ignition of the ignition retarder 15 takes place more reliably than if only one ignition pin—igniter combination were present.

For the sake of completeness, it is also pointed out that, as an alternative or in addition to the above-indicated possibilities for retarding the triggering of the second driving stage 5, other suitable implementations can be used, such as screens (not shown) for limiting the gas flow from the first to the second driving stage 4 and 5, in order to control the action upon an ignition piston 12 by mechanical retarding and triggering devices 9. Spacers (not shown) with desired breaking points between an ignition piston 12 and an igniter 14 can also be used, whereby the ignition piston 12 is not set in motion toward the igniter 14 before a defined force is applied in the first driving stage 4 which is-sufficient for destroying the desired breaking point of a spacer and thus open up the path to the igniter 14 for the ignition piston 12.

Several preferred design possibilities will be described in the following only as examples.

An electrically ignited cartridge as a first driving or triggering stage 4 is arranged in the same housing 16 with a cartridge which is situated opposite and is to be ignited particularly mechanically, as a second driving or triggering stage 5, such that the pressure surge of the first cartridge impacts on an ignition piston 12 with, for example, two ignition pins 21 and thus ignites the second cartridge (compare, for example, FIG. 4). For regulating the pressure surge and therefore a time delay, for example, a screen can be inserted as a throttle. As a result, it is achieved that the second stage 5 aids the first stage 4 such that a uniformly high pressure surge, which lasts as long as possible, drives the pistons, as illustrated schematically in FIG. 1.

The double or multiple cartridge can be called an adjusting device and, within the scope of the invention, can have an inner wall which is perforated for the gas outflow. An outer thin-walled sleeve can, for example, be slipped over, glued on against an entering of moisture and flanged. The outer sleeve can be so thin-walled that the pressure surge rips it open through the holes in the interior wall. As illustrated, for example, in the third embodiment in FIG. 4, the double cartridge can be disposed in and between the pistons.

As applications, the invention comprises basically all types of seat belt tensioning devices and other safety devices, particularly in automobiles, such as the buckle tightening device, the automatic belt tightening device, the belt end fitting device, the movement of seat ramps, knee paddings, brake pedals, cargo locking devices, steering system position changes, and others.

In particular, an operating system according to the invention with two-stage gas pressure generating devices can also be used in connection with those seat belts in the case of which, for the purpose of an improved comfort, the lap belt and the shoulder belt are rolled up by separate automatic mechanisms. An optimal safety can be achieved if the belt is tightened back simultaneously on both automatic devices or one automatic device and one end fitting or belt buckle. This is permitted by means of the present invention, specifically at reasonable cost and individually in that the new type of special tightener tightens back on both automatic devices. As the result of the pressure level which is constant longer than in the case of one-stage gas pressure generating devices and which can be created by means of the multi-stage gas pressure generating devices, the belt tightener driving elements, which are applied to both automatic devices, can be operated by means of joint gas pressure generating devices.

Another embodiment of an operating system for safety devices of a vehicle is illustrated in FIGS. 5 as well as 6a, 6b, 6c and 6d. This is a quadruple belt tightening device 31 which is housed in an extruded profile 32, particularly made of light metal and has joint gas pressure generating devices 3 for all four pistons 24a, 24b, 24c, 24d. In contrast to seat belt tighteners in the form of individual apparatuses, which are currently common, the integral combination of several apparatuses within the scope of the present invention requires only one pyrotechnic cartridge or action and an electric control circuit.

FIG. 5 illustrates the core of such a quadruple belt tightening device 31 according to the invention which has four pistons 24a, 24b, 24c, 24d. In this case, the pistons 24a, 24b, 24c may have the purpose of driving an automatic seat belt mechanism (not shown) by means of one Bowden cable 33 respectively. The piston 24d can be designed for tightening, for example, an end fitting of a belt (not shown) because it has a conventional ball lock 34 which locks the piston 24d once the end position of its operating path is reached. Between the piston ducts or guide paths 35, which are constructed in an integral manner with one another as a virtually double-run guide housing 23 for the individual pistons 24a, 24b, 24c, 24d, a cartridge duct 36 is situated as a pressure receiving space 27 which is provided in this case with a two-stage cartridge 37 as a two-stage gas pressure generating devices 3 and itself is also integrally constructed or assembled with the piston ducts 35. The guide housing 23 can, for example, be made of an extruded light metal profile. Two piston ducts or guide paths 35 respectively are housed in opposite directions in a run 23a and 23b of the double-run guide housing 23, so that the two runs 23a and 23b provide the four piston ducts or guide paths 35. This construction creates, for example, the advantage that, for the machining, only cut lengths of different extruded light metal profiles need to be fitted together and positioned, as, for example, by means of clinching.

FIGS. 6a, 6b, 6c and 6d are four sectional views of the extruded profile 32 in its longitudinal course, as used for quadruple belt tighteners 31 of FIG. 5.

FIG. 6a is a sectional view of the double-run guide housing 23 for the individual pistons 24a, 24b, 24c, 24d, in which case, as indicated by means of a comparison with FIG. 5, two piston ducts or guide paths 35 respectively extend behind one another in opposite directions. The extruded profile 32 virtually has double runs and can receive four pistons 24a, 24b, 24c and 24d which are inserted in opposite directions in pairs in each run 23a and 23b of the double-run guide housing 23.

The cartridge duct 36, which according to the representation in FIG. 5, is equipped with a two-stage cartridge 37 as two-stage gas pressure generating devices 3, is formed by a separate extruded profile 32′ which is inserted into the double-run guide housing 23 between the two runs 23a and 23b which form the piston ducts or guide paths 35 which are situated opposite one another in pairs. In addition to receiving the cartridge 37, the extruded profile 32′ supplements the shape and thus increases the stability of the pure guide housing 23.

Another extruded profile 32″ forms the portion of the pressure receiving space 27 which directly adjoins the cartridge duct 36, and is illustrated in FIG. 6c. This extruded profile 32″ is designed such that it guides the pyrotechnic pressure into both runs 23a and 23b of the guide housing 23 and thus behind all four pistons 24a, 24b, 24c and 24d. In addition to guiding the pressure gas from the cartridge 37 to the four pistons 24a, 24b, 24c and 24d, the extruded profile 32″ also supplements the shape and thus increases the stability of the pure guide housing 23. Furthermore, the extruded profile 32″ is used for positioning the four pistons 24a, 24b, 24c and 24d by stops 32″a. The sealing-off of the pressure receiving space or explosion space 27 takes place by labyrinth seals 32″b. The extruded profile 32″ contains a web 32″c in which a pressure compensation hole 32″d is situated which provides a uniform pressure distribution in the pressure receiving space 27 and particularly in the two runs 23a and 23b of the guide housing 23.

For a closure, the guide housing 23 has one lid 23′ respectively at each end, one of the lids being shown in FIG. 6d. The lid 23′ can be produced as a disk of another extruded profile. This lid 23′ has passages 23′a for Bowden cables 33 and an opening 23′b for the cartridge 37 to be inserted last during the manufacturing of the quadruple belt tightener 31. It is sufficient for only one of the two lids 23′ for a quadruple belt tightener 31 to have an opening 23′b, but, for reasons of a more efficient manufacturing, it may be provided that each lid 23′ has an opening 23′b, the opening 23′b in one of the two lids 23′ being closed without a previous inserting of a cartridge 37. The lids 23′ are clinched to the extruded profile 32 of the guide housing 23 and, as a result, also hold the extruded profiles 32′ and 32″ in place.

Without any limitation, in the case of the invention, instead of an operating system for safety devices with four pistons or driving elements in general, any other plurality of driving elements can be combined. Furthermore, it is not absolutely necessary within the scope of the invention that the guide housing for the multiplicity of the driving elements is in one piece, but several individual guide housings may also be assembled to a unit. Finally, the multi-stage gas pressure generating devices of the invention are not limited to a use in connection with a plurality of driving elements but can also be used for acting upon only one driving element.

With respect to additional characteristics, particularly of the gas pressure generating devices 3, in order to avoid repetitions, reference is made to the first to third embodiments according to FIGS. 2a, 2b, 2c, 3 and 4 which can be used here.

FIG. 7 is a sectional view of a fifth embodiment with gas pressure generating devices 3 which contain a two-stage cartridge 37 whose second stage 5 is ignited after the first stage 4 was ignited. The second driving stage 5 can be triggered by way of a triggering control 8 which contains mechanical retarding and triggering devices 9. Without limitations, reference is made with respect to common parts and characteristics of the fifth embodiment to the above descriptions of the first to fourth embodiments and the corresponding FIGS. 2a, 2b, 2c, 3, 4 and 5, in order to avoid repetitions.

The triggering or ignition of the first driving stage 4 in the case of the fifth embodiment has the result that, through the at least one gas passage duct 20 in the boundary wall 19 closing off the first driving stage 4 toward the second driving stage 5, the gas generated in the first driving stage 4 flows out not only into a pressure receiving space 27 (compare FIG. 5 as well as 6a, 6b, 6c and 6d) of a guide housing 23 (compare FIG. 5 as well as 6a, 6b, 6c and 6d) for at least one driving element 25 (compare FIG. 5 as well as 6a, 6b, 6c and 6d) for operating safety devices (not shown), but also flows out into a pressure collection space 38 which is situated between the first driving stage 4 and the second driving stage 5 and forms part of the ignition triggering mechanism 11 of the mechanical retarding and triggering devices 9. The latter also contain a bursting plate or disk 39 which closes off the pressure collection space 38 in the two-stage cartridge 37 toward the second driving stage 5.

The bursting plate 39 contains weakenings or weak points 39′ in the form of thin points at which the bursting plate 39 breaks at a defined gas pressure in the pressure collection space 38. So that a sufficient moving path is available for the breaking or bursting operation of the bursting plate 39, a free or soft zone 40 is provided between the latter and the actual second driving stage 5, in which steel wool may, for example, be situated. Instead of the bursting plate 39, a spring-braced or otherwise designed valve (not shown) may also be provided which opens up at a defined gas pressure in the pressure collection space 38. Through the burst bursting plate 39 or a corresponding valve (not shown) and the free or soft zone 40, hot pressure gas of the first driving stage 4 directly reaches the motive agent 41 of the second driving stage 5 and ignites this motive agent 41 and thus the second driving stage 5.

The gas generated by the second driving stage 5 after its ignition spreads through the free or soft zone 40, the bursting plate 39, whose fragments are possibly pressed into the pressure collection space 38, the pressure collection space 38 and the burned first driving stage 4 into a pressure receiving space of a guide housing for at least one driving element for operating safety devices (not shown here; see above description, for example, concerning FIG. 4 or 5 as well as 6a, 6b, 6c and 6d and FIG. 4 and 5 as well as 6a, 6b, 6c and 6d). The boundary wall 19, which closes off the first driving stage 4 toward the second driving stage 5, is preferably designed such that it is pressed away by the gas pressure of the second driving stage 5 and thus opens up the path for this gas flow unhindered into the first driving stage 4.

Double-igniting cartridges, for example, are very advantageous in the case of gas pressure generating devices of, for example, pyrotechnic drives for belt tighteners. As a result of a double explosion at an interval of, for example, 2 ms, the pressure receiving space or explosion space can be filled twice successively with pressure gas. During the first ignition, a smaller amount of gas is formed because the explosion space is still small in comparison to its later dimensions after the driving element, such as a piston, has moved. The movement of the piston, in which case, without limitations, preferably several pistons may also be acted upon simultaneously, enlarges the explosion or pressure receiving space in which then, in a time-delayed manner, as the result of the second explosion or ignition, for example, the same peak pressure can be reached, but with a larger amount of gas than in the first stage. As the result of the longer-lasting pressure level, for example, three times the amount of energy can be entered into the operating system, such as a belt tightening device, which, without being stressed more itself, can carry out a correspondingly larger amount of work.

Further embodiments of the invention will be illustrated in the following figures of the drawing, in which case as well as with respect to the design of the quadruple belt tightener according to FIG. 5 as well as 6a, 6b, 6c and 6d, designs and characteristics exceeding the multiple-stage drive are also in each case of a separate inventive significance and deserve to be protected particularly also together with one-stage operating systems and processes. This particularly applies to the design of the operating system with several driving elements, particularly pistons, and with load limiting devices for the driving elements.

With reference to FIG. 8, another embodiment will be explained only as an example by means of a pyrotechnic tightener 42, particularly for tightening seat belts (not shown) with load limiting devices 43.

In the present documents, a load limiting device 43 is a device which lowers the load upon an occupant when, after a collision, this occupant is pressed against the worn seat belt. The process takes place as follows: During a collision, the belt tightener of the seat belt is activated in order to eliminate the slackness of the belt. For this purpose, the seat belt is tightened by means of a force exercised by the pressure gas from the gas pressure generating devices by way of the driving elements. As the result of the collision, because of his inertia, the occupant is pressed against this force against the seat belt. If the force exercised by the occupant upon the seat belt becomes higher than the force which the belt tightener currently applies, the driving element would be withdrawn again. This is counteracted, for example, by the ball lock 34 for the piston 24d described in connection with FIG. 5. If, as a result, the piston 24d is now abruptly braked, a high load upon the occupant occurs because he is now pressed with full force against the seat belt. This loading is to be reduced by the load limiting device 43, which will first be explained with reference to FIG. 8.

FIG. 8 shows a belt buckle tightening device 44 with gas pressure generating devices 3 in the form of a two-stage cartridge 37, with respect to whose design possibilities reference is made to those in connection with FIGS. 2a, 2b, 2c, 3, 4 and 7. In order to avoid repetitions with respect to FIG. 8, details of the gas pressure generating devices 3 will not be explained separately.

The belt buckle tightener 44 has a cable linkage which does not, as customary nowadays, take place directly to the piston 24 acting as the driving element 25. Between the piston 24 and a thimble 45 for linking the cable, such as a Bowden cable 33, for transmitting the movement from the driving element 25 to a belt buckle (not shown), a load-absorbing device 46 is mounted which has the purpose of reducing load peaks when the piston by means of a return blocking device (not shown) is locked with respect to a withdrawal which occurs because the force which the occupant exercises upon the seat belt is higher than the force which is available for the movement of the piston 24.

The example of FIG. 8 shows a deformable corrugated pipe 47 which folds up under a load. The corrugated pipe 47 is connected between the piston 24 and the thimble 45 so that, by way of the corrugated pipe 47, the piston 24 pushes the thimble 45 ahead of itself when it is acted upon with pressure gas from the gas pressure generating devices 3. Because of a counterforce on the Bowden cable 33 against the pull by the force of the occupant onto the seat belt (not shown) when the piston 24 is blocked against a withdrawal, the deformable corrugated pipe 47 can fold up under the load of the thimble 45 acted upon by the occupant by way of the seat belt (not shown) via the Bowden cable 33. This ensures that no abrupt peak load is exercised on the occupant when the piston 24 is blocked against a return and the occupant continues to press increasingly against the seat belt (not shown). This further reduces the risk of injury to the occupant.

So that the system will not buckle, the thimble 45 is guided by means of a guiding tube 48. The corrugated pipe 47 is only one example of load-absorbing devices 46, such as deforming elements. According to the desired characteristic load curve (constant, rising, stepped), nesting elements and inhomogeneous structures (pipes with slots, corrugated pipes of different wall thicknesses, etc.), for example, are also conceivable.

As mentioned above, the belt buckle tightener 44 is equipped with a two-stage cartridge 37 or generally a multi-stage cartridge. The end-side seal 49 of the piston duct or guide path 35 and the simultaneous cable guidance by a corresponding edge design of the piston 24 are further cost-saving elements.

FIG. 9 shows a double piston tightener 50 which is particularly suitable for the application to seat benches (Not shown) and for the tightening of belt buckles (not shown). Both pistons ducts or guide paths 35 for the two pistons 24a, 24b are, detachably from one another in the center, connected with one another, for example, by means of threads. This is used for the inserting of the pyrotechnic cartridge, such as the illustrated two-stage cartridge 37, in the last pass during the manufacturing of the double piston tightener 50. In addition, the cartridge can be changed in this manner in the event of a determined functional disturbance or a malfunctioning.

As in FIG. 8, gas pressure generating devices 3 and load-absorbing devices 46 as load limiting devices 43 are also used here. The construction according to FIG. 9 has the advantage that it requires only a two-stage cartridge 37 for two belt tighteners and load limiting devices which have completely separate courses.

FIGS. 10a and 10b show a modification of the construction in FIG. 9 with an arrangement for difficult, particularly narrow, space conditions. In the design according to FIG. 10b, the gas pressure generating devices 3 are arranged next to the piston ducts or guide paths 35 for the two pistons 24a, 24b, of which only the piston 24a is visible, and permit a pressure gas supply between the two pistons 24a, 24b.

FIG. 11 shows a general expansion of the load limiting to two levels. Here, the embodiment of a load limiting device explained above with reference to FIGS. 8, 9 and 10 is supplemented by the possibility of a telescoping of a divided cylinder pipe 51. The load of this telescoping is limited by a surrounding load-limiting or load-absorbing device 46 in the form of a deformable pipe, such as a corrugated pipe 47. The load limiting pipe must be displaceable. In general, that is, for all embodiments described above and in the following, other applications as tightening devices for belt buckles are also conceivable, as easily recognized by a person skilled in the art.

Other variants of load-limiting or load-absorbing devices 46 are “programmable” load limiting devices 43. The embodiment described in the following with reference to FIG. 12, according to another aspect, shows the possibility of adapting the characteristic load curve of load-limiting or load-absorbing devices 46 individually, for example, to the requirements of occupants of different weights or different accident sequences and severity.

For this purpose, a hydraulic liquid 52, such as silicone oil or grease, particularly such a hydraulic liquid 52 with a low change of viscosity at temperature fluctuations, is situated in the embodiment according to FIG. 12 between the thimble 45 and the piston 24. In order to hold the hydraulic liquid 52 securely between the thimble 45 and the piston 24, the latter are tightly connected with one another by means of a corrugated pipe 47 in that, for example, the corrugated pipe 47 is flanged on its ends with the thimble 45 and the piston 24. As a result, the corrugated pipe 47, together with the thimble 45 and the piston 24, forms a container 53 for the hydraulic liquid 52, which can be deformed and particularly upset along the connection line of the thimble 45 and the piston 24. The corrugated pipe 47 itself generates a part of the characteristic load limiting curve in the manner explained in connection with the embodiments according to FIGS. 8 to 11.

In the embodiment according to FIG. 12, the thimble 45 has a nozzle 54 which, when not in use, can be tightly closed, for example, by means of a stopper 55. A nozzle needle 56 is fastened on the piston 24, the tip of the nozzle needle 56 pointing to the stopper 55 in the nozzle 54′ of the thimble. When a load is exercised onto the thimble 45 against the blocked piston 24, the nozzle needle 56 pushes open the stopper or the closing cap 55 out of the nozzle 54 and moves through the nozzle 54 which has a larger diameter than the nozzle needle 56. As a result, the hydraulic liquid 52 must be pressed through a ring gap formed between the nozzle needle 56 and the nozzle 54. According to the size of the ring gap, a counterpressure is created which varies. Superimposed on the folded tube, this counterpressure determines the characteristic load limiting curve. Along its longitudinal course, the nozzle needle 56 may have different diameters and/or shapes, which affects the size and shape of the ring gap. As a result, the damping performance of the load limiting device 43 can be controlled.

In order to provide a facilitated passage for the hydraulic liquid, such as oil or grease, as an additional possibility, for example, in the event of an excessive pressure because of a serious accident or when the hydraulic liquid is very cold, a pressure relief valve 57, for example, in the form of an elastic sleeve, is situated in the thimble 45, in order to reduce unacceptable pressure levels. This pressure relief valve 57, as recognizable by a person skilled in the art, can also be constructed as a spring, a closing piston and/or a pressure piston in a controlling manner.

The “programmable” load limiting device 43 according to the embodiment of FIG. 12 is particularly simple and effective, which otherwise could only be achieved at very high expenditures in the case of an automatic belt device. Because of the simple construction, the load limiting device can be varied at low cost and to a very high degree.

The above-explained embodiments illustrated in FIGS. 8 to 12 relate to a belt buckle tightening device 44 whose load limiting device 43 contains a corrugated pipe 47 between the thimble 45 and the piston 24, which corrugated pipe 47, when a pull is exercised on the belt (not shown) is pulled together. By means of this construction, a definable or defined, for example, rising characteristic load curve can be implemented.

As another special characteristic, it is suggested in the case of the variant according to FIG. 12 to connect the actual belt unlatching buckle by means of a Bowden cable with a locking buckle. This has the advantage that the unlatching buckle can be fixedly mounted on a movable seat; that is, is always at the same site for the user. The “locking buckle” is mounted on the vehicle-fixed seat bottom part.

In another embodiment, a seat cross traverse 58 is provided which has an integrated belt tightening device 42 with a load limiting device 43, which is described in detail in the following with reference to FIG. 13. This variant relates to an optimizing of the safety requirements in the event of a side crash, by means of the design and the arrangement of the seat structure and the belt tightener.

For optimizing the lateral stiffness of an automobile, as illustrated in FIG. 13, the supporting cross traverses of an individual passenger car seat 59 are placed as high as possible between a door sill 60 and a transmission tunnel 61. For this purpose, the runners 62 must be placed on edge. The cross traverse 58 which is in the rear in the driving direction is constructed in a tube-shaped manner such that this tube can simultaneously operate as a housing 63 of the transversely arranged belt tightener 42 with the load limiting device 53. The housing 63 is fastened to the longitudinal guide rails 62. If, as in the illustrated example, the housing 63 consists of two tubes 64 and 65 fitted into one another, this housing 63 is simultaneously used as a pivot bearing 66 in the case of vertically adjustable seats 59. The deflection of the cables or Bowden cables 33 of the belt tightening device 42 can be implemented by means of a, for example, cast, divisible block 67 which is inserted into the inner tube 64 slotted for the passage of the cable 33. The electric feed lines (not shown) for the electric contacts 6 can be displaced in the seat rail 62.

The additional advantages achieved by means of this construction are that the cross traverse of the seat is simultaneously used for a stabilizing against a side crash and receives the belt tightening device which, as a result, does not require any additional receiving space. In this case, the belt tightener housing is a supporting part for the seat structure and against a side crash. Space, weight and costs are saved as a result.

FIGS. 14 and 15 show additional embodiments of load limiting devices 43.

A cutting version of a load limiting device is illustrated in FIG. 14. The load limiting device contains cutting blades 68 which are embedded in the piston 24. The cutting blades 68 are disposed to be tilting such that, in the event of a pulling-back on the Bowden cable 33 by a tensile load by the occupant on the connected seat belt (not shown), when this load has become higher than the force onto the piston 24 by the action of the gas pressure generating devices (not shown here), they are tilted out of the piston 24 by a driving plate 69. The return movement of the piston 24 has the result that the cutting blades 68 are pressed into the wall 70 of the piston duct 35 and dig in there. The reverse movement of the piston 24 against its loading direction according to the arrow A by means of the gas pressure generating devices (not shown here) has the result that the cutting blades 68 each peel a sliver 71 out of the wall 70 of the piston duct 35. The force required for this purpose dampens and limits the tensile force causing this action. The height of the sliver 71 is precisely limited by a contact surface 72 integrated in the cutting blade 68. The extent of the load limiting is determined by the width and the height of the peeled-out sliver 71, the material of the wall 70 and the number of cutting blades 68. This results in a low-cost and space-saving construction of a load limiting device, for example, for a seat belt.

FIG. 15 illustrates a load limiting device 43 which has a deforming effect. For this purpose, balls or rolls 73 are provided which are arranged in wedge spaces 74 on the edge within the piston 24. The wedge spaces 74 are designed such that, when the piston 24 moves forward, the balls or rolls 73 are taken along by the pressure gas from the gas pressure generating devices (not shown here), without generating an effect. When the movement of the piston 24 is reversed, for example, because of the fact that the force of the occupant onto the seat belt (not shown) connected to the piston 24 by way of the Bowden cable 33 has become higher than the force of the gas pressure from the gas pressure generating devices (not shown here), the balls or rolls 73 are pressed by self-energy and friction into the narrower area of their wedge spaces 74 and are jammed in there between the piston 24 and the wall 70. As the result of the used materials for the piston, the balls or rolls 73 and the wall 70 as well as the shape of the wedge spaces 74, a dent-type material deformation in the wall is created with an increasing withdrawal force onto the piston 24 by each ball or roll 73. At the narrower ends 75, the wedge spaces 74 are dimensioned and shaped such that holding shoulders 76 are formed there which project beyond the center line of the balls or rolls 73 so that the latter are held in a form-locking manner and cannot slide through between the holding shoulders 76 and the deformed wall 70. This also results in a low-cost and space-saving construction of a load limiting device, for example, for a seat belt.

In addition to the characteristics and combinations of characteristics indicated in the preceding description, the figures of the drawings and the claims, the present invention comprises without limitations all concepts, principles and generalizations which can easily be recognized by a person skilled in the art on the basis of his special knowledge. In particular, all variations, combinations, modifications and substitutions of the individual embodiments as well as from the technical knowledge of a person skilled in the art are within the scope of the invention.

What is claimed is:

1. Operating system for safety devices in a vehicle, comprising:
a guide housing,
at least one driving piston housed therein which is coupled to at least one safety device for operation,
an operating path in the guide housing for the driving element,
at least one gas pressure generating device for generating a gas pressure in a pressure receiving space in the guide housing, and
starting devices for triggering the gas pressure generating device,
wherein the at least one driving piston is capable of being acted upon by generation of a gas pressure in the pressure receiving space for movement from an inoperative position along the operating path,
wherein the gas pressure generating device contains at least two successively triggerable driving stages and a triggering control by which the generation of the gas pressure by at least two successive driving stages takes place sequentially with a predetermined delay but in a partially superimposed manner, and
a load limiting device coacting with the driving piston which ensures a predetermined yielding performance of the safety device to which the driving piston is coupled.

2. Operating system according to claim 1, wherein the triggering control contains retarding and triggering devices which are any of mechanical, chemical, electric and electronic and which can be triggered by a driving stage which triggers a correspondingly following driving stage.

3. Operating system according to claim 2, wherein the retarding and triggering devices include chemical and mechanical retarding and triggering devices with the chemical retarding and triggering devices are connected behind the mechanical retarding and triggering devices.

4. Operating system according to claim wherein the mechanical retarding and triggering device contains an ignition triggering mechanism which can be operated by a triggered first driving stage, and an igniter for the driving stage which follows the triggered driving stage, and wherein a delay between triggerings of two successive driving stages is definable by a time duration of a sequence of the ignition triggering mechanism and ignition performance of the igniter.

5. Operating system according to claim 4, wherein the ignition triggering mechanism contains an ignition piston and a valve, and wherein the ignition piston can be moved toward the igniter of the following driving stage.

6. Operating system according to claim 5, wherein the mechanical retarding and triggering device contains a valve by which gas flows between two successive driving stages can be controlled and wherein the valve is closed until triggering of the following driving stage by a triggered driving stage and then opened in order to ensure an operation of the ignition piston in the closed condition and a gas flow from the following driving stage into the pressure receiving space in the open condition.

7. Operating system according to claim 6, wherein the valve is provided in the ignition piston.

8. Operating system according to claim 3, wherein the mechanical retarding and triggering device contains an ignition triggering mechanism which can be operated by a triggered driving stage and a delay between triggerings of two successive driving stages is determinable by the time duration of the sequence of the ignition triggering mechanism.

9. Operating system according to claim 8 wherein the ignition triggering mechanism contains a pressure collection space which can be filled with pressure gas by a triggered driving stage and which separates the triggered driving stage from the following driving stage which is to be triggered subsequently, and a threshold device which closes off the pressure collection space toward the following driving stage which is to be triggered subsequently and opens it at a defined pressure in the pressure collection space in order to cause the ignition of the following driving stage by the pressure gas of the triggered driving stage.

10. Operating system according to claim 9, wherein the threshold device is a bursting disk.

11. Operating system according to claim 10, wherein the bursting disk bursts weakenings for determining the gas pressure in the pressure collection space at which the bursting disk bursts.

12. Operating system according to claim 10, wherein a free or soft zone is provided between the bursting disk and the driving stage to be triggered in order to provide a sufficient path for bursting of the bursting disk.

13. Operating system according to claim 4, wherein the first driving stage can be triggered electrically or electronically.

14. Operating system according to claim 1, wherein the predetermined delay is approximately 1 ms to approximately 5 ms, after triggering of the first driving stage.

15. Operating system according to claim 1, wherein the at least one safety device is one of a belt tightening device and an adjusting device.

16. Operating system according to claim 1, wherein a plurality of guide paths and corresponding driving pistons can be acted upon by joint gas pressure generating devices by way of a provided pressure receiving space.

17. Operating system according to claim 16, wherein the guide housing contains an extruded profile which optionally contains a plurality of guide paths.

18. Operating system according to claim 1, wherein the gas pressure generating devices are constructed as at least one cartridge and are mounted on or in the guide housing.

19. Operating system according to claim 1, wherein a second driving stage generates a larger amount of gas than a first driving stage.

20. Operating system according to claim 1, wherein the load limiting device ensures a predetermined yielding performance of the safety device to which the driving element is coupled, blocking the driving piston against a return when acted upon by a counterforce force higher than the force by an occupant.

21. Operating system according to claim 1, wherein the load limiting device is provided between a piston and a thimble coupling the driving piston to a safety device.

22. Operating system according to claim 1, wherein the load limiting device is at least one of material-deforming, cutting and hydraulic.

23. Operating system according to claim 1, wherein the guide housing is a cross traverse which forms a reinforcing part of a vehicle structure.

24. Operating process for safety devices in a vehicle comprising the steps of:
providing a pressure receiving space in which gas pressure acts along an operating path upon at least one driving piston coupled to at least one safety device, and
generating gas pressure in the pressure receiving space by at least two successive and partially superimposed gas pressure surges generated by triggering first and second successive individual driving stages of the gas pressure generating devices to operate the at least one safety device via movement of said piston.

25. Operating process according to claim 24, and further comprising the steps of triggering a first of said driving stages and activating at least one of mechanical, chemical, electric and electronic retarding and triggering devices to trigger a following driving stage as a result.
